(19) United States
(12) Patent Application Publication
(10) Pub. No.: US 2006/0129437 A1
(43) Pub. Date: Jun. 15, 2006

(54) Map-based flight searching and booking method

(75) Inventors: Ronald Lee, Sindian City (TW); Gino Li, Sindian City (TW)

Correspondence Address: BACON & THOMAS, PLLC, 625 SLATERS LANE, FOURTH FLOOR, ALEXANDRIA, VA, 22314, US

(73) Assignees: Ronald Lee, Sindian City (TW); Gino Li, Sindian City (TW)

(21) Appl. No.: 11/184,904

(22) Filed: Jul. 20, 2005

(30) Foreign Application Priority Data
Dec. 9, 2004 (TW) 093138109

(51) Int. Cl. G06Q 10/00

(52) U.S. Cl. 705/5

(57) ABSTRACT

This invention discloses a map-based flight searching and booking method used in an electronic device, and the electronic device includes a display unit. The method comprises the steps of: (A) providing a map to the electronic device for being displayed on the display unit, the map including a plurality of location options; (B) providing a plurality of route options of a plurality of airline companies to the electronic device for being displayed on the map of the display unit; (C) receiving an airline company selection command comprising a selected airline company, so as to display the routes of the selected airline company on the map of the display unit; and (D) receiving a route selection command comprising a selected route, and providing a flight option corresponding to the selected route, wherein the flight option includes at least one menu, and the menu has a plurality of condition settings.

### BACKGROUND OF THE INVENTION

1. Field of the Invention

The present invention relates to a flight searching and booking method, and more particularly, to a map-based flight searching and booking method.

2. Description of Related Art

With the trend of globalization, fast and convenient transportation is an extremely important issue. For example, delivering passengers to places around the world on time via air transportation obviously improves business operation and the way of living. However, it becomes a complex task between agencies and passengers about immediately booking and ordering tickets, and taking the airplane on time toward the destination. Conventionally, the airline companies and travel agencies spend a lot of labor cost to handle the booking matters for passengers, and the passengers also have to go to the airline company or the travel agency counters in person, or keep checking the ticket and flight status by phone. This is really a time-exhausting process, which doesn't comply with the actual requirement. It's very inconvenient especially when the passenger requires an emergent ticket ordering, or changes his/her flight in a sudden.

Due to the development of Internet, the airline companies or travel agencies start to provide on-line booking websites for providing the on-line booking service. The user only has to enter the on-line booking website or TV, and provides appropriate data, such as: ID, name, departure date, return date, ticket or room amount, and cabin or room class. Next, the user chooses the payment method, including: by credit card or wire transfer. Finally, the airline companies or travel agencies process ticket/room reservation services to the airline companies or hotels according to the above data, and then deduct the expense from user's payment. Comparing with the conventional booking procedure, this improved on-line booking service is much more convenient and time-saving for users to make ticker/room reservation.

However, the above improved on-line booking service still encounters some problems. For example, the user has to fill in many fields for the booking procedure, thereby this service is not suitable for those passengers in a hurry. Furthermore, there're a lot of variables which may influence the booking result; therefore, the passenger needs to keep communicating with the customer service center, perhaps several times, until a best flight is confirmed. It's not only inefficient, but also time-consuming and cost-wasting. Therefore, it is desirable to provide an improved flight searching and booking method to mitigate and/or obviate the aforementioned problems.

### SUMMARY OF THE INVENTION

The present invention relates to a map-based flight searching and booking method used in an electronic device having a display unit. The method comprises the steps of: (A) providing a map to the electronic device for being displayed on the display unit, the map including a plurality of location options; (B) providing a plurality of route options of a plurality of airline companies to the electronic device for being displayed on the map of the display unit, wherein each route is between two of the plurality of location options; (C) receiving an airline company selection command including a selected airline company, so as to display the routes of the selected airline company on the map of the display unit; and (D) receiving a route selection command including a route selected according to the routes displayed on the map, so as to provide a flight option corresponding to the selected route, wherein the flight option includes at least one menu, and the menu has a plurality of condition settings. Consequently, through the map-based interface operation, the user can easily select the flight, origin or destination, so as to complete such as the flight searching, booking, ticketing, or changing services.

The method further comprises step (A1) executed prior to step (A), between steps (A) and (B), or between steps (B) and (C), for receiving an origin for determining the route options provided to the electronic device for being displayed on the display unit.

Moreover, the electronic device has an identification code, and there are two steps executed prior to step (A): (A2) recording a plurality of personal identification codes each corresponding a plurality of booking histories; and (A3) comparing the identification code of the electronic device with the plurality of personal identification codes, and if the identification code of the electronic device matches one of the personal identification codes, providing a simplified service according to the booking histories of the matched personal identification code. The simplified service can be used under the following conditions: directly executing step (B) by skipping step (A); directly executing (C) by skipping steps (B) and (C); or directly executing step (D) by skipping steps (A), (B) and (C).

After the above step (D), the method further comprises step (E):

comparing the condition setting selected by the electronic device with a plurality of flight data stored in a database, so as to obtain at least one flight matching the condition setting, and provide the at least one flight, its corresponding flight information and a back-end service option to the electronic device for being displayed on the display unit, wherein the database can be the database of the electronic device, or the database of a remote server. If no matching flight can be find, the method then returns back to step (B) for retrieving other airline company information.

The electronic device of the present invention can be a personal computer, personal digital assistant (PDA), Tablet PC, mobile communication device or other equivalent devices. The plurality of flight data stored in the database of step (E) can be provided by the build-in database of the electronic device, or can be obtained by connecting to the remote server via the network. The aforementioned map can be a world map, a regional map or a local map, such as an East Asia map, a Europe map, and etc.

Other objects, advantages, and novel features of the invention will become more apparent from the following detailed description when taken in conjunction with the accompanying drawings.

### BRIEF DESCRIPTION OF THE DRAWINGS

FIG. 1A depicts a schematic block diagram of one preferred embodiment according to the present invention;

FIG. 1B illustrates a flowchart of the preferred embodiment according to the present invention;

FIG. 2 depicts a world map of the preferred embodiment according to the present invention;

FIG. 3 depicts a schematic drawing of selecting airline company routes of the preferred embodiment according to the present invention;

FIG. 4 illustrates a menu of the preferred embodiment according to the present invention;

FIG. 5 illustrates a flight of the preferred embodiment according to the present invention;

FIG. 6A depicts a schematic block diagram of another preferred embodiment according to the present invention; and

FIG. 6B illustrates a flowchart of the second preferred embodiment according to the present invention.

### DETAILED DESCRIPTION OF THE PREFERRED EMBODIMENT

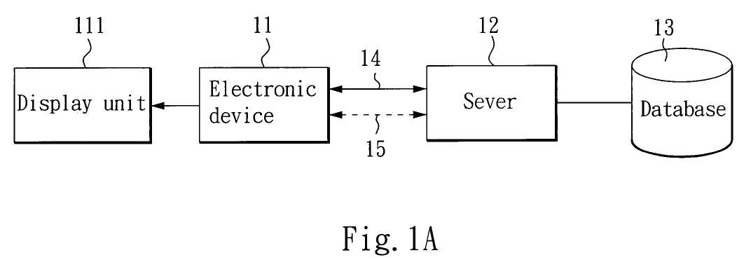

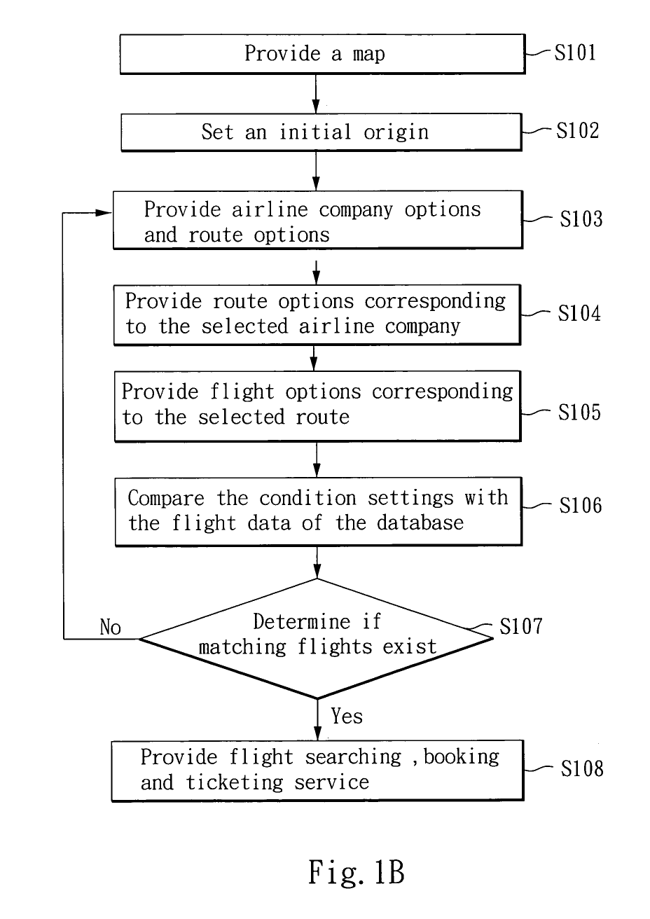

Please refer to FIG. 1A, which depicts a schematic block diagram of one preferred embodiment according to the present invention. The present invention is used in an electronic device 11, which includes a display unit 111. In this embodiment, the electronic device 11 connects to a remote server 12 via wired network 14 or wireless communication 15, and searches the auxiliary database 13 of the server 12 to obtain required information.

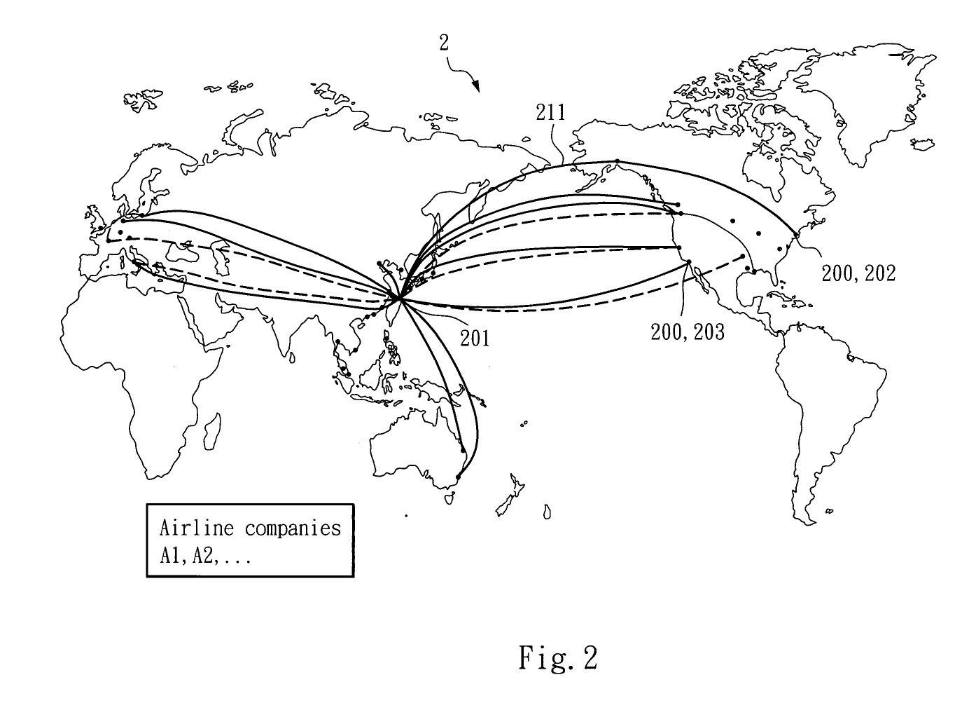

FIG. 1B illustrates a flowchart of the preferred embodiment according to the present invention. At first, a map, for example a world map 2 as shown in FIG. 2, is provided and displayed on the display unit 111 of the electronic device 11 (S101). Alternatively, the map can be a regional map or a local map. With reference to FIG. 2, multiple location options 200 are listed on the world map 2, such as Taipei 201, New York 202, Los Angeles 203, and etc. Next, an initial origin is selected from the world map 2 (S102). In the embodiment, Taipei 201 is selected as the initial origin. Then, the server 12 provides the electronic device 11 with the route options 211 of multiple airline companies A1, A2 . . . by taking Taipei 201 as the origin. Please refer to FIG. 2, the route options 211 of different airline companies A1 and A2 in this embodiment are marked as different types of lines, while these route options 211 can also be marked as different colors of lines, or other distinguishable presentations. Please note that each route 211 is between any two of the location options 200, and a plurality of airline company options A1, A2 . . . are also provided on the world map 2 for user selection (S103).

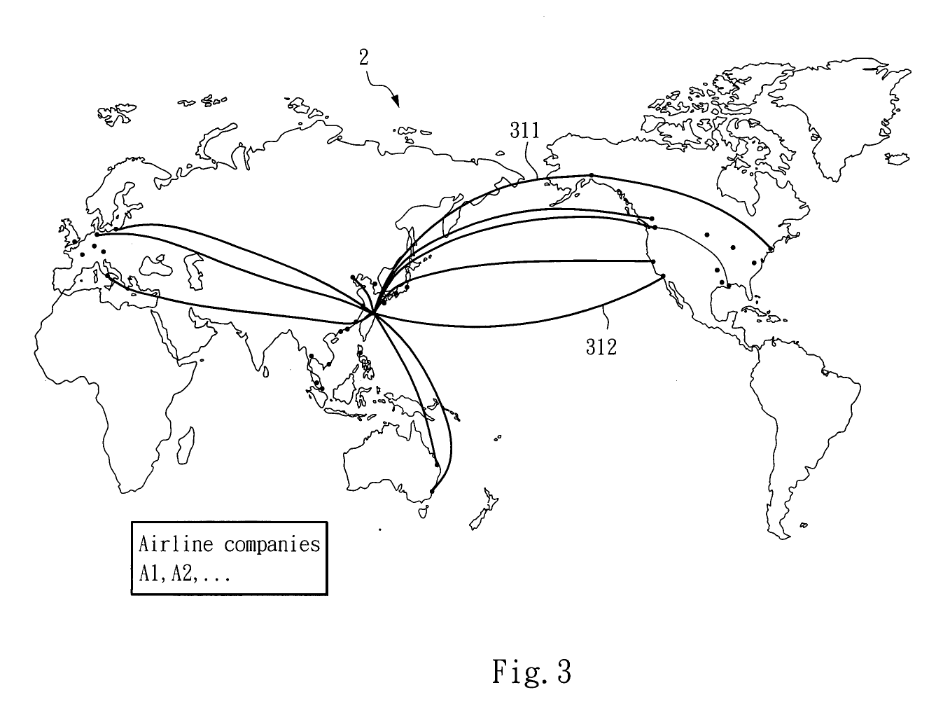

The server 12 then receives an airline company selection command which comprises a selected airline company A1. Please also refer to FIG. 3, which depicts a schematic drawing of selecting airline company routes of the preferred embodiment according to the present invention. As shown in FIG. 3, the user selects airline company A1, such that only the routes 311 of airline company A1 are displayed on the world map 2, while the rest routes belonging to other airline companies A2 . . . would not be displayed (S104).

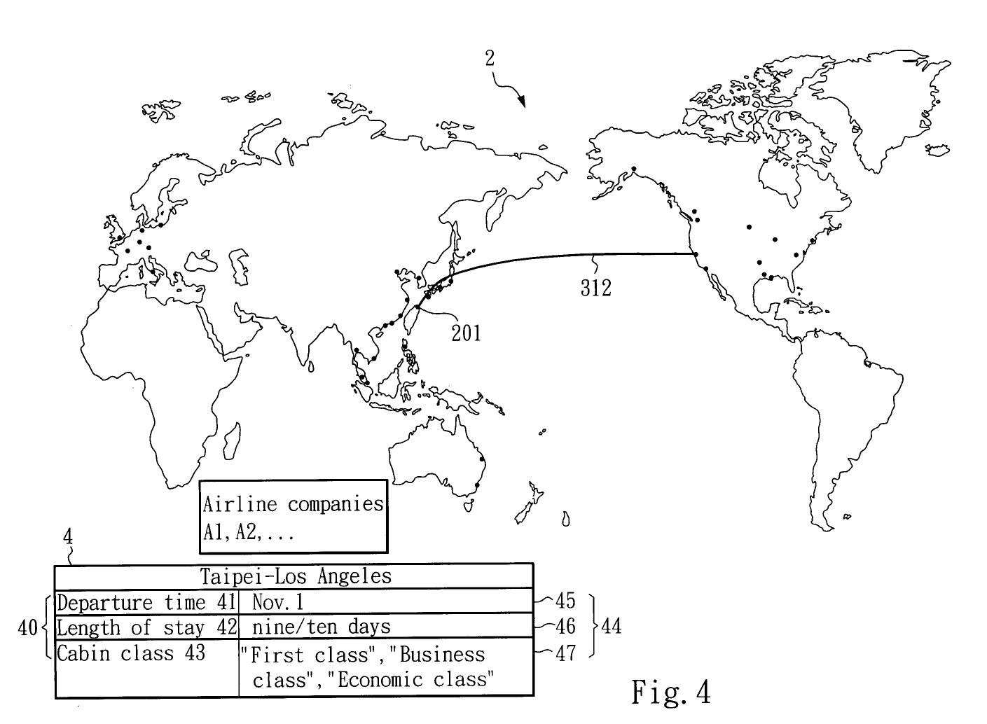

With reference to FIG. 4, once the user selects the route 312, this route 312 is then displayed on the world map 2 of the display unit 11, and the corresponding flight option 4 including multiple menus 40 is also provided. As shown in FIG. 4, the menus 40 include, for example, a departure time menu 41, a length of stay menu 42, a cabin class menu 43, and etc. Further, each menu is defined with a plurality of corresponding condition settings 44 for use selection. For example, these condition settings include the date condition 45, the length of stay condition 46, the cabin class condition 47, and the like. In the embodiment, the user selects Taipei 201 as the origin, Los Angeles 203 as the destination, November 1 as the departure date condition 45, nine/ten days as the length of stay condition 46, and ‘first class’, ‘business class’ and ‘economic class’ as the cabin class condition 47. Please note that the user can select more than one setting for the above conditions, so as to provide a flexible adjustment facility. Consequently, those flights matching the condition settings would be retrieved and displayed on the display unit 111 for user selection.

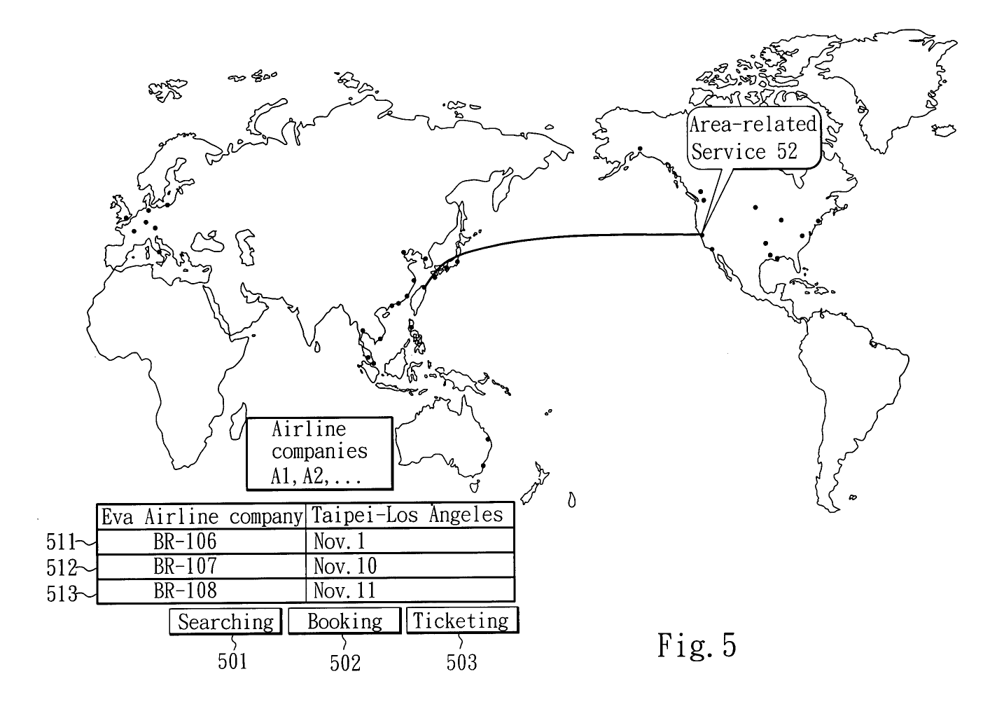

After user selection, the server 12 compares the condition settings 44 selected by the user with a plurality of flight data stored in its database 13 in order to obtain corresponding flights marching the condition settings 44 (S106). Then, the server 12 determines whether at least one matching flight exists (S107). If so, the server 12 provides the matching flight, its corresponding flight information and a back-end service option to the electronic device 11 for being displayed on the display unit 111 (S108); otherwise, the flowchart returns to step S103 for re-selecting other airline companies. Please refer to FIG. 5, which illustrates a flight of the preferred embodiment according to the present invention. The remote server of the present embodiment finds that the ‘economic class’ of flight ‘BR-106’ 511, ‘BR-107’ 512 and ‘BR-108’ 513 of airline company A1 match the condition settings, such that the server lists the above searched flights for user selections. Meanwhile, the server further provides a searching option 501, a booking option 502 and a ticketing option 503 for the user to choose a more detailed content of the listed flights, such as the corresponding boarding time, ticket price, number of remaining seats, boarding gate number, and etc. Moreover, the user can directly choose a preferred flight to process the booking, reserving and ticketing service.

Furthermore, after selecting the route in step S104, an area-related service 52 corresponding to the selected route is provided to the electronic device 11 for user's reference. For instance, the area-related service 52 can be the introduction of Disneyland, relevant information of Universal Studio, the searching service for resorts or hotels near Los Angeles, and the like.

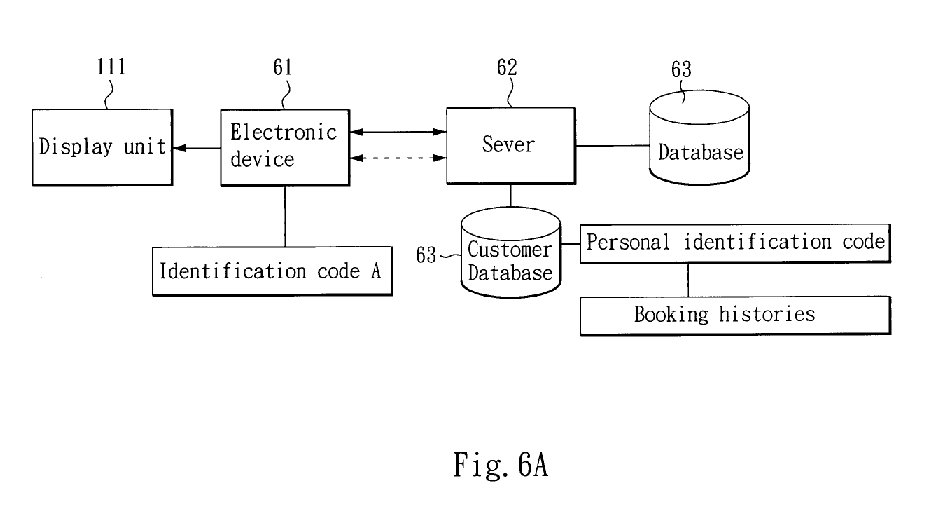

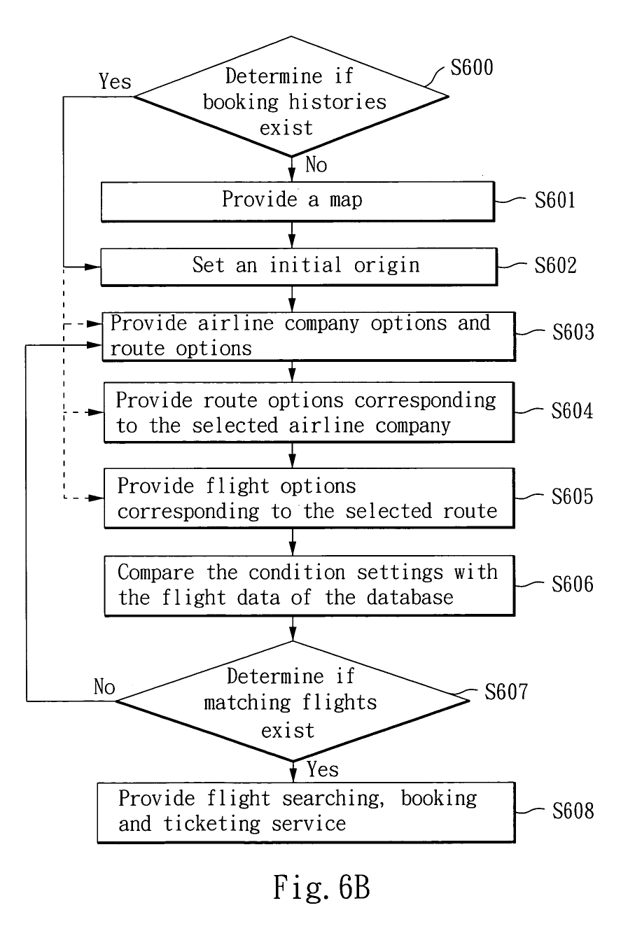

FIG. 6A depicts a schematic block diagram of another preferred embodiment according to the present invention. The electronic device 61 of this embodiment has an identification code A, and the remote server 62 further has a customer database 66, which is recorded with a plurality of personal identification codes (I₁, I₂ . . . ), each corresponding to a plurality of booking histories (H₁, H₂ . . . ). Please also refer to FIG. 6B illustrating a flowchart of this second embodiment according to the present invention. Steps S601 to S608 of FIG. 6B are identical to Steps S101 to S108 of FIG. 1B. The only one difference between FIG. 6B and FIG. 1B is that FIG. 6B further comprises step S600 for retrieving matching booking histories (H₁, H₂ . . . ) by comparing the identification code A of the electronic device 61 with the personal identification codes (I₁, I₂ . . . ) of the customer database 66, so as to provide a simplified service according the booking histories (H₁, H₂ . . . )(S600). For example, the remote server 62 retrieves the previous booking histories (H₁, H₂ . . . ) after receiving the identification code A, and finds out that the booking histories (H₁, H₂ . . . ) implies that the user always selects Taipei 201 as the origin, and takes the flight of Airline company A1. According to the booking histories (H₁, H₂ . . . ), the server 62 assumes the possibility of selecting Taipei 201 as the origin, and taking the flight of airline company A1 is very high; therefore, the server 62 skips steps S601 to S603, and directly provides the electronic device 61 with the route departing from Taipei 201 of airline company A1, thereby omitting the inconvenient selecting procedure.

However, if the user is not willing to take the flight of airline company A1 at this time, he/she may directly refer to the airline company options (A1, A2 . . . ) on the world map 2 for selecting another airline company A2. Alternatively, if the user wishes to depart from New York 202 at this time, he/she may directly select the location option of New York 202 on the world map 2 for reviewing those flights departing from New York 202. Obviously, the present invention is easy for the user to make changes and selections.

Although the present invention has been explained in relation to its preferred embodiment, it is to be understood that many other possible modifications and variations can be made without departing from the spirit and scope of the invention as hereinafter claimed.

What is claimed is:

1. A map-based flight searching and booking method used in an electronic device, the electronic device including a display unit, the method comprising the steps of:
(A) providing a map to the electronic device for being displayed on the display unit, the map including a plurality of location options;
(B) providing a plurality of route options of a plurality of airline companies to the electronic device for being displayed on the map of the display unit, wherein each route is between two of the plurality of location options;
(C) receiving an airline company selection command including a selected airline company, so as to display the routes of the selected airline company on the map of the display unit; and
(D) receiving a route selection command including a route selected according to the routes displayed on the map, so as to provide a flight option corresponding to the selected route, wherein the flight option includes at least one menu, and the at least one menu has a plurality of condition settings.

2. The map-based flight searching and booking method as claimed in claim 1, further comprising:
(E) comparing the condition setting selected by the electronic device with a plurality of flight data stored in a database, so as to obtain at least one flight matching the condition setting, and provide the at least one flight, its corresponding flight information and a back-end service option to the electronic device for being displayed on the display unit.

3. The map-based flight searching and booking method as claimed in claim 1, further comprising the following step prior to step (C):
(A1) receiving an origin for determining the route options provided to the electronic device for being displayed on the display unit.

4. The map-based flight searching and booking method as claimed in claim 1 further comprising the following steps prior to step (A), wherein the electronic device further has an identification code:
(A2) recording a plurality of personal identification codes each corresponding to a plurality of booking histories; and
(A3) comparing the identification code of the electronic device with the plurality of personal identification codes, and if the identification code of the electronic device matches one of the personal identification codes, providing a simplified service according to the booking histories of the matched personal identification code.

5. The map-based flight searching and booking method as claimed in claim 4, wherein the simplified service is selected from the conditions of: directly executing step (C), and directly executing step (D).

6. The map-based flight searching and booking method as claimed in claim 1, wherein in step (A), the map is a world map, regional map or local map.

7. The map-based flight searching and booking method as claimed in claim 2, wherein if no matching flight is obtained by comparing the condition setting with the plurality of flight data in step (E), step (B) is executed for retrieving other airline company information.

8. The map-based flight searching and booking method as claimed in claim 2, wherein in step (E), the back-end service option comprises a booking option and a searching option for respectively providing a booking service and a searching service.

9. The map-based flight searching and booking method as claimed in claim 1, further comprising the following step after step (D):
(F) providing an area-related service corresponding to the route according to the route selection command received in step (D).

10. The map-based flight searching and booking method as claimed in claim 9, wherein the area-related service include relevant travel information corresponding to the route.

11. The map-based flight searching and booking method as claimed in claim 1, wherein the menu is a departure time menu having a plurality of departure times.

12. The map-based flight searching and booking method as claimed in claim 11, wherein the at least one condition setting corresponding to the menu is at least one selected date condition.
